(19) United States
(12) Patent Application Publication
(10) Pub. No.: US 2013/0098816 A1
(43) Pub. Date: Apr. 25, 2013

(54) Mobile water purification station

(71) Applicant: International Water Company, Cheyenne, WY (US)

(72) Inventor: Robert W. Elfstrom, Sea Bright, NJ (US)

(73) Assignee: International Water Company, Cheyenne, WY (US)

(21) Appl. No.: 13/573,953

(22) Filed: Oct. 16, 2012

Related U.S. Application Data
(60) Provisional application No. 61/627,706, filed on Oct. 17, 2011.

(51) Int. Cl. C02F 1/00

(52) U.S. Cl. CPC C02F 1/00
USPC 210/153

(57) ABSTRACT

The present invention relates to a mobile water purification station capable of producing up to 30,000 gallons (151,400 lpd) of EPA/WHO-standard clean and aesthetically pleasing potable water per day which is self contained and operates as a stand-alone unit powered by integrated solar array and wind generator or utilizing gravity feed from a water source located above the geographic location of the unit. Furthermore, the mobile water purification station of the present invention, provides a parallel arrangement of filtration and purification elements and is able to continuously provide potable water while half the system is undergoing cleaning and regeneration by back flushing with stored prior produced potable or filtered utility water.

### FIELD OF INVENTION

The present invention relates to a mobile water purification station having the capability of producing up to 30,000 gallons (151,400 lpd) of EPA/WHO-standard clean and aesthetically pleasing potable water per day without the need for purification chemicals or regular replenishment of filter media. The device will supply potable water for over 5,000 people at a rate of 5+ gallons (18.92 lpd) per day per person. Powered by an integrated solar array and wind generator or gravity feed, the device also supports optional power sources of battery, 2.5 kw generator, and AC line voltage (50-60 hz, 30-300V). The device is operable as a stationary stand-alone with either trailer- or vehicle-mount options and is designed for delivery to any location by land, sea or air for completely self-contained production of potable water from available natural water sources.

### BACKGROUND OF INVENTION

In developing countries and areas hit by natural disasters such as floods, earthquakes, hurricanes, and the like, contaminated water is extremely problematic, leading to widespread infection and disease. Where municipal water purification and delivery systems are damaged or compromised, the availability of sufficient quantities of potable water is often not reliable.

Conventional methods of providing sufficient quantities of potable water in disaster areas are limited in efficacy and feasibility. For example, water is often brought into disaster areas in large containers which is expensive, cumbersome and very often not sufficient to meet demand. Alternatively, treating contaminated water on site by accepted methods including boiling and use of chemical disinfectants does not eliminate endotoxins, other undesirable chemicals or radiation, and may have unwanted side effects.

Other disadvantages of attempts to provide easily transportable water purification systems have included the lack of sufficient redundancy to ensure high quality product in the event of a breakdown; requirement of ready availability of replacement parts, such as filter elements; easy operation by untrained individuals. These factors present particular problems in under developed and undeveloped areas where replacement parts and technical expertise is frequently not available.

What is needed is a completely self-contained, mobile water purification station which can be shipped, trucked or air-lifted into locations on short notice to provide a reliable source of potable water without the need for chemicals, replaceable filters, or technical expertise and which can provide both potable and non-potable, filtered utility water for agriculture, laundry, bathing, etc. In addition, what is needed is a system that is self cleaning by backwashing with filtered or potable reserve water, thereby reducing or, possibly, eliminating the need for technical maintenance or replaceable filter media.

### SUMMARY OF THE INVENTION

There is a need for a simple, low cost and effective mobile water purification station which provides potable water for over 5,000 people at a rate of at least 5 gallons per day.

The present invention provides a mobile water purification station capable of producing up to 30,000 gallons (151,400 lpd) of EPA/WHO-standard clean and aesthetically pleasing potable water per day.

In addition, the mobile water purification station of the present invention requires no external power source and operates as a stand-alone unit powered by integrated solar array and wind generator or utilizing gravity feed from a water source located above the geographic location of the unit.

Furthermore, the mobile water purification station of the present invention, due to the parallel arrangement of filtration and purification elements can continuously provide potable water while half the system is undergoing cleaning and regeneration by back flushing with stored prior produced potable or filtered utility water.

It is therefore an object of this invention to provide a skid or trailer mounted mobile water purification station for the production of up to 30,000 gallons (151,400 lpd) of EPA/WHO-standard clean and aesthetically pleasing potable water per day.

It is a further object of this invention to provide a mobile water purification station for use in marginal terrain, overland travel, air-drop, and/or seaborne delivery and which is engineered for long term trouble-free service with little to no maintenance.

It is a still further object of the present invention to provide a mobile water purification station having the ability to include post-treatment, fully mechanical metered injection pump means to ensure the integrity of previously-compromised storage facilities when operated as an inline chlorinator.

In particular, the present invention provides self-contained, stand-alone, mobile water purification station capable of producing up to 30,000 gallons of EPA/WHO standard potable water without chemicals comprising:

an enclosure housing an erectable solar array, an erectable wind generator, a battery pack, at least one submersible pump and connecting hose, and a water filtration and purification assembly comprising two parallel water treatment systems operable separately or concurrently to produce filtered utility water and/or purified potable water,

wherein each of the parallel water treatment systems comprises at least one sediment filter, at least one heavy metals filter, at least one activated carbon filter, at least one pre-filter and at least one ultra-filter plumbingly connected in series for water flow therethrough in order from the sediment filter through the ultra-filter, and

wherein each of the parallel water treatment systems is operable to provide filtered or purified water apart from the other of the parallel water treatment systems, and wherein each of the parallel water treatment systems is separately backflushable using purified water produced by the station to maintain optimum operability.

Further, the present invention provides an improved self-contained, stand-alone, mobile water purification station comprising an enclosure, an erectable solar power array, an erectable wind generator, a battery pack, at least one submersible pump and connecting hose, water purification units and water storage tanks, the improvement comprising;

the water filtration and purification units arranged within said enclosure in two, identical and parallel and separate systems, each system comprising at least one loose media sediment filter, at least one loose media heavy metals filter, at least one loose media activated carbon filter, at least one porous sintered metal pre-filter and at least one porous sintered metal ultra-filter, each filter having a water inlet and a water outlet, the filters being connected in series for water flow therethrough in order from the sediment filter through the ultra-filter, the two identical and parallel systems being separably operable one from the other to produce filtered and purified water;

a raw water inlet connectable to the submersible pump and receiving water from the pump to be filtered and purified by the units, the raw water inlet being connected to water inlets of each of the loose media sediment filters by a first pair of separate manually operable shut off valves whereby raw water is directable to one or the other or both of the parallel systems;

a potable water outlet connectable to water outlets of each of the porous, sintered metal ultra-filters and receiving filtered and purified water produced by the units, the potable water outlet being connected to each of the ultra-filters by a second pair of separate manually operable shut off valves whereby filtered and purified water is receivable from one or the other or both of the parallel systems;

at least one ultra-violet, flow through, water disinfecting unit connected between the second pair of separate manually operable shut off valves and the potable water outlet;

the water storage tanks comprising a potable water storage tank disposed within the enclosure and connected to the water filtration and purification units between the at least one ultra-violet flow through water disinfecting unit and the potable water outlet and adapted to receive and store the filtered and purified water, the potable water storage tank being separable from the water filtration and purification units by a single manually operable shut off valve;

the water storage tanks further comprising an intermediate water storage tank disposed within the enclosure and connected to the water filtration and purification units between the loose media activated carbon filters and the porous sintered metal pre-filters, the intermediate water storage tank being separable from the water filtration and purification units by a manually operable shut off valve at each loose media activated carbon filter;

a back flush system for the water filtration and purification units whereby the loose media filters and the porous sintered metal filters are backflushable separate and apart from production of filtered and purified water, and wherein the porous sintered metal filters are backflushable, separately or in combination, using filtered and purified water produced by the water filtration and purification units, the back flush system comprising a manifold receiving back flush water from each filter, the manifold having a back flush discharge directing back flush water from the enclosure, and the back flush system comprising positive closure one-way valves at the porous sintered metal filters whereby reverse flow of back flush water is prevented;

whereby the self-contained, stand-alone mobile water purification station is adapted to produce filtered utility water and purified potable water to EPA/WHO standards, separately or in combination, and the filters are backflushable within the station using water produced by the station for regeneration and re-use.

Still further, the present invention provides a self-contained, stand-alone mobile water purification station comprising an enclosure, a raw water inlet into the enclosure, a submersible pump connectable to the raw water inlet and adapted to provide raw water to the mobile water purification station;

the raw water inlet plumbingly connected to first and second water inflow control valves, the first water inflow control valve plumbingly connected to a first water treatment system and the second water inflow control valve plumbingly connected to a second water treatment system;

the first and second water treatment systems being disposed in parallel arrangement within the enclosure, the first and second water treatment systems each comprising a sediment filter, a heavy metals filter, an activated carbon filter a first particle pre-filter and a second particle ultra-filter, the filters being plumbingly connected in series between inflow and outflow ports thereof;

the outflow of each of the second particle ultra filters plumbingly connected to first and second outflow control valves, the ultra filter of the first water treatment system connected to the first outflow control valve and the ultra-filter of the second water treatment system connected to the second outflow control valve;

the outflow control valves plumbingly connected to ultra-violet flow through water disinfecting units, outflow from the ultra-violet units plumbingly connected to a purified water discharge means;

an intermediate filtered water storage tank disposed within the enclosure and plumbingly connected to a mid-flow take-off point between the activated carbon filter and the first particle pre-filter of each of the first and second water treatment systems;

a filtered and purified water storage tank disposed within the enclosure plumbingly connected to the purified water discharge means by a purified water storage conduit downstream of the ultraviolet units and separable therefrom by an on-off control valve;

the purified water storage tank further plumbingly connected to the first and second particle pre-filters of the first and second water treatment systems by a main back flush flow plumbing conduit coming off of the purified water storage conduit and separable therefrom by an on-off control valve, the main back flush flow conduit providing flow of stored purified water for back flushing the particle pre-filters separate from said particle ultra-filters;

a back flush discharge system separate from the filters and plumbing connections therebetween, the back flush system comprising back flush discharge hoses connecting each filter to and back flush manifold, the manifold including on-off valves for each of the particle pre-filters and the particle ultra-filters, and the manifold directing back flush water from the filters to a back flush discharge outside of the enclosure, wherein the back flush discharge and the raw water inlet are on a side of the enclosure opposite from the purified water discharge means; and

a solar power generation array and a wind power generator stored within the enclosure and erectable on the outside of the enclosure providing electrical power for at least the submersible pump, wherein the pump provides sufficient force to generate at least 60 psi within the water treatment systems, the pump force being sufficient to operate the water treatment systems.

Further objects and advantages will be evident from the following drawings and description.

### BRIEF DESCRIPTION OF THE DRAWINGS

FIG. 1 is an oblique view of the mobile water purification station of the present invention mounted on a trailer and with solar panels and wind generator deployed.

FIG. 2 is an oblique end view of the mobile water purification station showing operating controls.

FIG. 3 is a close end view of the preferred embodiment of the mobile water purification station with rear doors removed showing controls, filtration tanks, storage tanks and conduits.

FIG. 3A is a close end view of an alternative embodiment of the mobile water purification station including a centrifugal sediment filter for incoming water.

FIG. 4 is a top view of the water purification system showing the parallel structure and connections between filters.

FIG. 5 is a schematic view of the water purification system and process of providing purified water.

FIG. 6 is a schematic view of the water purification system and process for back flushing the system.

FIGS. 7A, 7B and 7C illustrate valve settings and water flow through loose media filters for water production (7A), back flushing (7B) and rapid rinse resetting (7C).

FIG. 8 is a close-up view of the back wash manifold.

FIG. 9 is a schematic view showing an alternative embodiment providing dedicated back flush for first and second pre-filters.

### PARTS LIST

The following is a list of the elements of the present invention as identified in the accompanying drawings and following description.
1 MWPS
2 trailer
3 solar array
4 wind generator
5 enclosure
6 generator mast
7 rear lockable doors
7′ front lockable doors
8 side access panels
9 water purification assembly
10 upper storage space
10′ center storage space
11 hitch
12 stabilizers
13 wind turbine blades
14 submersible pump
14′ pump screen
15 IO 101 control box
16 IO 102 control box
17 CU 200 control box
18 centrifugal filter
19 back flush manifold
20 left intake control valve
21 right intake control valve
22 left discharge control valve
23 right discharge control valve
24 irrigation discharge valve
25 drain valve
26 left sediment filter valve
27 right sediment filter valve
28 left heavy metals filter valve
29 right heavy metals filter valve
30 left activated carbon filter valve
31 right activated carbon filter valve
32 left intermediate water cutout valve
33 right intermediate water cutout valve
34 intermediate water discharge valve
35 left UV lamp discharge valve
36 right UV lamp discharge valve
37 potable water tank isolation valve
38 potable water discharge valve
39 potable water drain valve
40 separator back flush valve
41 left pre-filter back flush valve
42 right pre-filter back flush valve
43 left micro-filter back flush valve
44 right micro-filter back flush valve
45 injection pump inlet valve
46 injection pump supply side valve
47 left micro-filter injection pump valve
48 right micro-filter injection pump valve
49 injection pump discharge side valve
50 left sediment filter
51 right sediment filter
52 left heavy metals filter
53 right heavy metals filter
54 left activated carbon filter
55 right activated carbon filter
56 left pre-filter
57 right pre-filter
58 left micro-filter
59 right micro-filter
60 intermediate water storage tank
61 potable water storage tank
62 raw water intake
63 back flush discharge
64 potable water discharge
65 injection pump
66 bulkhead
67 solar panels
68 pivoting support frame
69 left ultra-violet lamp
70 right ultra-violet lamp
71 first pressure gauge
72 second pressure gauge
73 third pressure gauge
74 fourth pressure gauge
75 main electrical box
76 filter array
77 left side filters
78 right side filters
79 one way valve
80 left filtered water hose
81 right filtered water hose
82 UV lamp feed line
83 potable water collection hose
84 fiberglass tank
85 filter media
86 gravel bed
87 perforated plate
88 three way valve
89 filter valve intake hose
89′ left side filter intake hose
89″ right side filter intake hose
90 filter valve discharge hose
91 filter valve back flush discharge
92 tube
93 left common back flush hose
94 right common back flush hose
95 left pre-filter back flush hose
96 right pre-filter back flush hose
97 left micro-filter back flush hose
98 right micro-filter back flush hose
99 disinfectant lines
100 CU 200 control box ON/OFF switch
101 IO 101 control box ON/OFF switch
102 IO 102 control box ON/OFF switch
103 indicator lamp
104 watt meter
105 left and right pre-filter main back flush line
106 left pre-filter secondary back flush line
107 right pre-filter secondary back flush line
108 left pre-filter back flush inflow valve
109 right pre-filter back flush inflow valve
110-115 one way valves
116 main back flush line isolation valve
117 T-fitting
118 intermediate water line
119 left pre-filter to ultra-filter connection line
120 right pre-filter to ultra-filter connection line

### DETAILED DESCRIPTION OF THE INVENTION

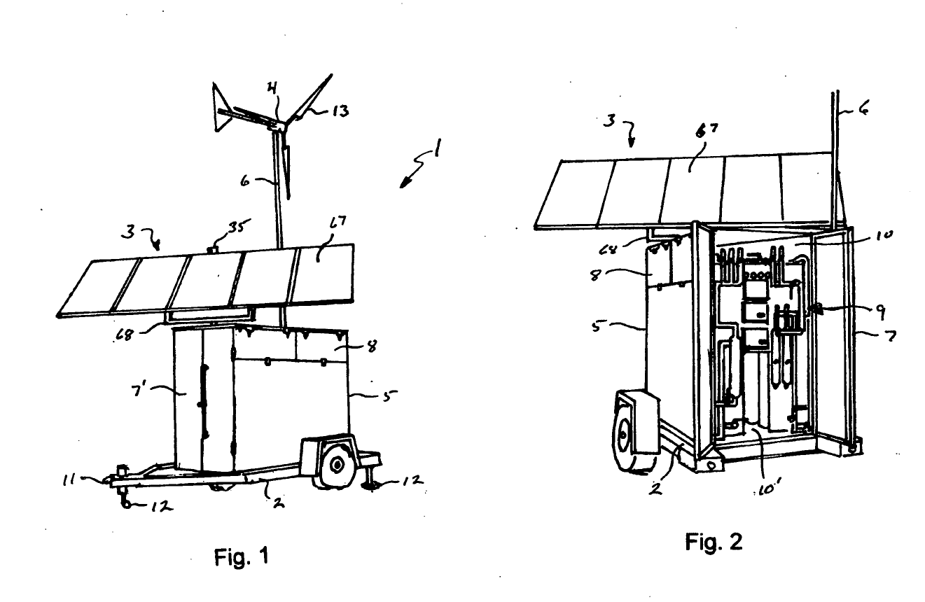

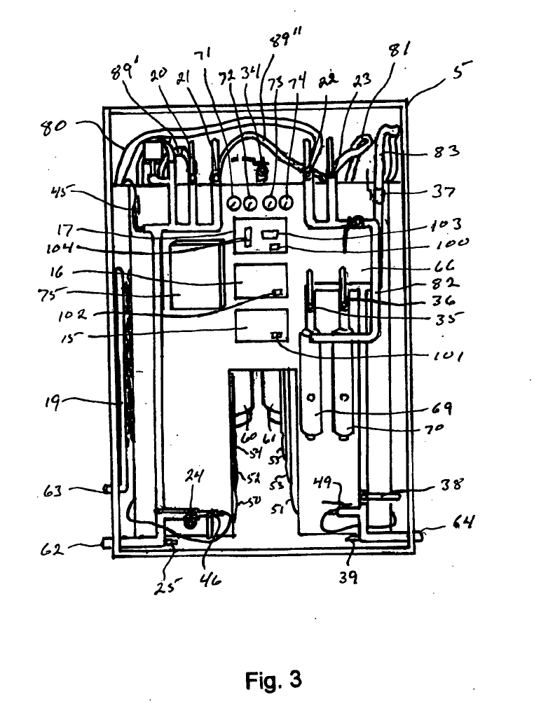

Referring to FIGS. 1 and 2, the mobile water purification station 1 (MWPS) is shown mounted on a trailer 2 for easy transportation behind any vehicle capable of towing 4,000 to 6,000 pounds depending on the station's operational configuration. The station may also be skid-mounted for either mobile or permanent installations. In either form, the station can be shipped by sea, ground or air, including the ability for delivery by parachute deployment. Trailer 2 includes a front hitch 11 and extendable and retractable stabilizers 12.

The station can operate by simple gravity flow of water from a raised reservoir or using ground water supplied by a self contained pump from any ground water source. Electricity to power the pump and ultraviolet disinfection units is supplied by solar array 3, wind generator 4, or both, with space provided within enclosure 5 for storage and shipping of dismantled array 3 and generator 4. Generator mast 6 is sectional or telescopic and is collapsible or retractable for storage and shipping. Optional power sources include batteries, 2.5 kw generator, and AC line voltage (50-60 hz, 30-300V).

Enclosure 5 includes lockable doors 7, 7′ at each end providing access to water purification assembly 9, upper storage space 10 and center storage space 10′. In addition, side access panels 8 provide access to plumbing and related connections of water purification assembly 9 within enclosure 5. Solar array 3 comprises individual panels 67 which can be disassembled to fit in central storage space 10′ which preferably includes guide rails or supports for panels 67. Pivoting support frame 68 is removable from enclosure 5 above front doors 7′ and fits in upper storage space 10. Wind generator 4 is demountable from mast 6 and blades 13 are removable permitting generator 4 and blades 13 to be stored in enclosure 5.

Pivoting support frame 68 and associated solar array 3 are located at the forward end of enclosure 5 above front doors 7′, whereas the main control elements of mobile water purification station 1 are accessed through rear doors 7. In this manner, with front end of mobile water purification station oriented toward the sun, rear end is substantially shaded by the bulk of enclosure 5. Solar array 3 may include a motor and tracking means providing automatic tracking for solar array 3 of the sun's path for optimal power generation. Solar array may comprise fewer or more than the five panels illustrated dependent on ultimate power requirements and panel efficiency.

Water purification assembly 9, which includes filtration units, plumbing, valves, manifolds, operational controls, water storage tanks and all necessary hoses, connections and conduits, is assembled within enclosure 5. However, alternatively, assembly 9 may be mounted on a support frame which may be slidably positionable within enclosure 5 for easy removal and replacement. Releasable latch means between frame and enclosure may be provided to secure frame and associated elements when installed within enclosure 5. Alternatively, frame may be bolted to floor and/or sides of enclosure 5. Such a frame may also serve as a pallet engagable by a fork lift or similar apparatus for insertion and removal of filtration assembly 9 relative to enclosure 5.

Furthermore, enclosure 5 may be removably secured to trailer 2 and may include attaching points at upper corners for a crane and/or pallet openings front and rear at the bottom to accommodate a fork lift.

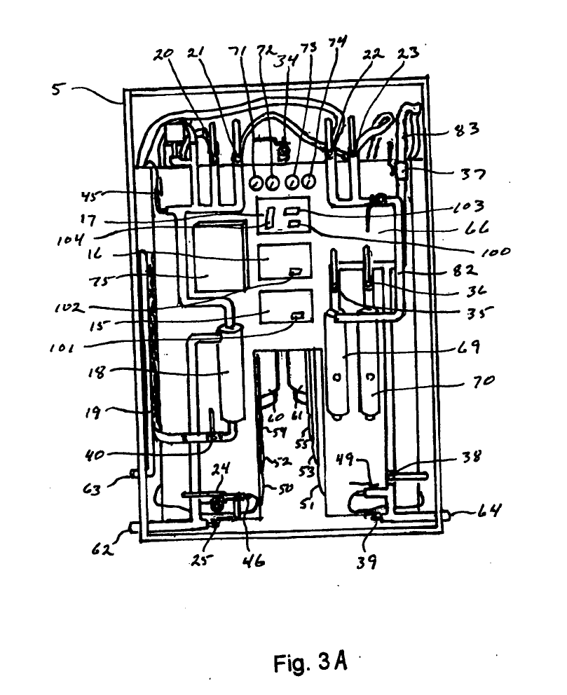

FIG. 3 presents a view of water purification assembly 9 within enclosure 5 when rear doors 7 are open for operation. Enclosure 5 is divided by bulkhead 66 which provides a mounting surface for IO 101 control box 15, IO 102 control box 16 and CU 200 control box 17, centrally located on bulkhead 66 above center storage space 10′. Bulkhead 66 extends about three fourths the height of enclosure 5, thereby leaving access to upper storage space 10. Above CU 200 control box 17 are pressure gauges 71, 72, 73, 74 providing pressure readouts for the assembly 9, gauge 71, ultra-filters 58, 59, gauges 72, 73, and for potable water tank 61, gauge 74.

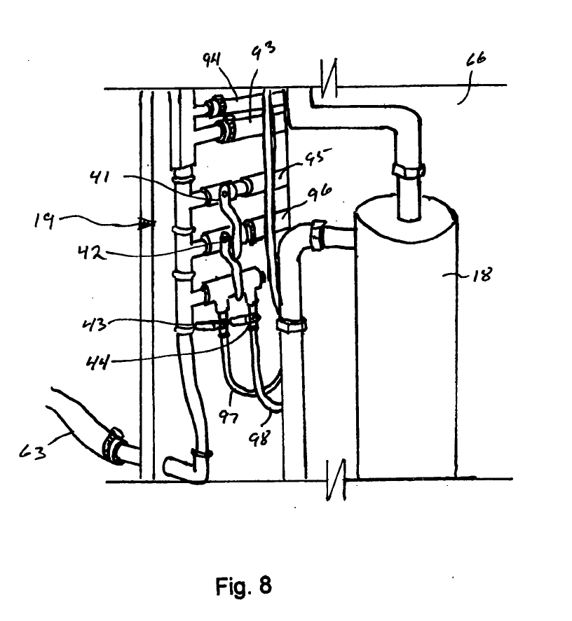

On the left side-wall of enclosure 5, adjacent to bulkhead 66 is back flush manifold 19, illustrated more clearly in FIG. 8, providing valves 41, 42, 43, 44 controlling back flushing of pre-filters 56, 57 and micro-filters 58, 59 as will be described later, as well as connection of back flush lines for filter tanks 50, 51, 52, 53, 54, 55 to back flush discharge 63.

In the principal embodiment, the left side of bulkhead 66 is considered the “dirty” side and is where incoming raw water is received at intake 62 and where back flush discharge 63 is located. Right side of bulkhead 66 is the “clean side” where potable water discharge 64 is located. This separation of “dirty” and “clean” on opposite sides of enclosure 5 reduces the risk of contamination.

Raw water enters the system from submersible pump 14 at raw water intake 62 and may flow first through a centrifugal filter 18 mounted on left side of bulkhead 66. Centrifugal filter 18 is an optional element providing initial removal of particles and sediment on the order of 15 to 25 microns. However, under most circumstances, initial screening filters 14′ on submersible pump 14 are sufficient to provide initial sediment removal. Submersible pump 14 may be a variable speed pump or a plurality of pumps of different speed and/or capacity may be provided with the unit. Preferably MWPS 1 is supplied with one pump providing 11 gallons per minute flow and one pump providing 25 gallons per minute flow. As noted previously, each pump 14 includes a pump screen 14′ as an initial sediment filter. Optionally, the system may include a selection of interchangeable pump screens 14′ of different pore size for use in water of varying turbidity.

Also mounted to bulkhead 66 is main electrical box 75 containing electrical control circuitry necessary to modify and control voltage and current supplied by solar array 3 and/or wind generator 4 to that required to operate pump 14, ultraviolet lamps 69, 70, and optional equipment such as tracking means for solar array 3, satellite communication means, auxiliary lighting, etc. Box 75 may include or be connected to an electrical outlet such that solar array 3 and/or wind generator 4 may be used to provide useful electricity in the field.

Above box 75, at the upper edge of bulkhead 66 are manual intake control valves 20, 21 which divide and control flow of water from centrifugal filter 18 to left and right sides of filter array 76 as will be described later.

On the right side of bulkhead 66 at the top thereof are manual discharge control valves 22, 23 which receive and, in combination with control valves 20, 21 control flow of water through filter array and out to UV lamps 69, 70, secured to bulkhead 66 below valves 22, 23. UV lamps 69, 70 are provided with manual discharge valves 35, 36 permitting them to be used separately or concurrently and providing discharge of completely filtered and disinfected potable water through potable water discharge valve 38 to potable water discharge outlet 64. Alternatively, potable water exiting UV lamps 69, 70 through valves 35, 36 may be directed to potable water storage tank 61 through potable water isolation valve 37.

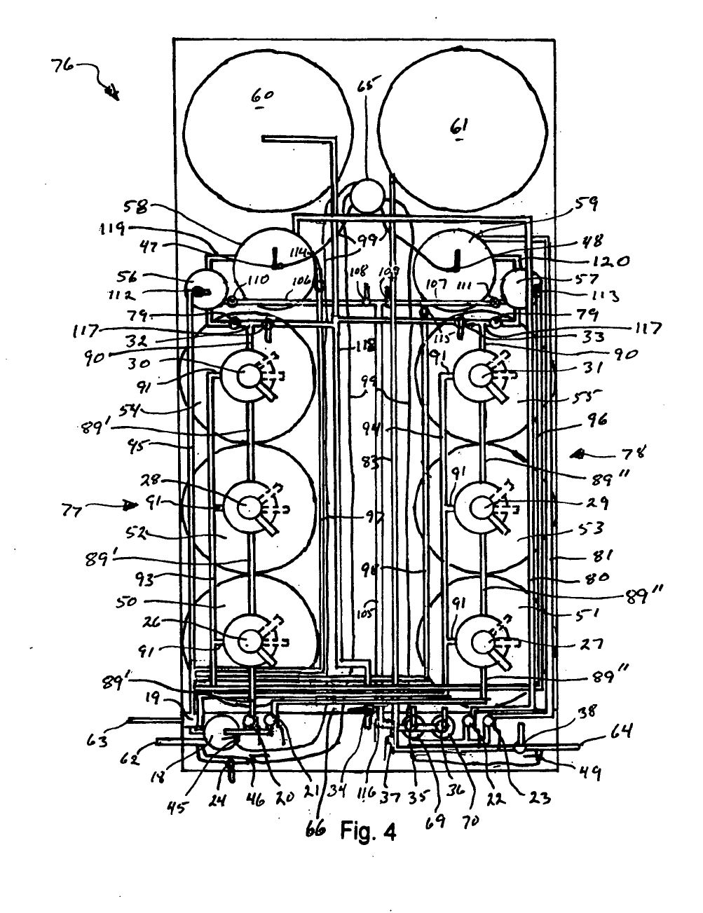

Turning to FIG. 4, filter array 76 resides behind bulkhead 66 and comprises left and right sediment filters, 50, 51, left and right heavy metals filters 52, 53, left and right activated carbon filters 54, 55, left and right pre-filters 56, 57 and left and right micro-filters 58, 59. Filter array 76 is divided to form identical assemblies of filters with left filters 50, 52, 54, 56, 58 connected in series as the left side 77 and right filters 51, 53, 55, 57 and 59 connected in series as the right side 78.

Left intake control valve 20 connects to left sediment filter 50 through left sediment filter valve 26 via left side filter intake hose 89′. Left sediment filter 50 connects serially to left heavy metals filter 52 through left heavy metals filter valve 28 via continuation of hose 89′ which, on left sediment filter valve 26 is filter discharge hose 90 and on left heavy metals filter valve 28 is intake hose 89. Similarly, left heavy metals filter 52 connects serially to left activated carbon filter 54 through left activated carbon filter valve 30 via a further continuation of hose 89′ which, on the left heavy metals filter valve 28 is filter discharge hose 90 and on the left activated carbon filter valve 30 is intake hose 89.

Discharge hose 90 from left activated carbon filter 54 connects at T-fitting 117 to left pre-filter 56 through one way valve 79 on one side of T-fitting 117 and to intermediate water line 118 through left intermediate water cutout valve 32 on the other side of T-fitting 117. Thus, water passing serially through left media filters 50, 52 and 54, is directed either to further filtration through left pre-filter 56 or, via intermediate water line 118 to storage in intermediate water storage tank 60 or discharge through intermediate water valve 34.

Outflow of left pre-filter 56 connects serially to left ultra-filter 58 via left pre-filter to ultra-filter connection line 119 and outflow of left ultra-filter 58 connects to left filtered water hose 80 which then connects to left discharge valve 22, providing flow of filtered water from left side 77 through UV lamps 35, 36 which connect to potable water storage tank 61 through potable water tank isolation valve 37 and potable water connection hose 83 or to potable water discharge 64 through potable water discharge valve 38.

Similarly, on right side 78, right intake control valve 21 connects to right sediment filter 51 through right sediment filter valve 27 via right side filter intake hose 89″. Right sediment filter 51 connects serially to right heavy metals filter 53 through right heavy metals filter valve 29 via continuation of hose 89″ which, on right sediment filter valve 27 is filter discharge hose 90 and on right heavy metals filter valve 29 is intake hose 89. Similarly, right heavy metals filter 53 connects serially to right activated carbon filter 55 through right activated carbon filter valve 31 via a further continuation of hose 89″ which, on the right heavy metals filter valve 29 is filter discharge hose 90 and on the right activated carbon filter valve 31 is intake hose 89.

Discharge hose 90 from right activated carbon filter 55 connects at a T-fitting 117 to right pre-filter 57 through one way valve 79 on one side of T-fitting 117 and to intermediate water line 118 through right intermediate water cutout valve 33 on the other side of T-fitting 117. Thus, water passing serially through right media filters 51, 53 and 55, is directed either to further filtration through right pre-filter 57 or, via intermediate water line 118 to storage in intermediate water storage tank 60 or discharge through intermediate water valve 34.

Outflow of right pre-filter 57 connects serially to right ultra-filter 59 via right pre-filter to ultra-filter connection line 120 and outflow of right ultra-filter 59 connects to right filtered water hose 81 which then connects to right discharge valve 23, providing flow of filtered water from left side 78 through UV lamps 35, 36 which connect to potable water storage tank 61 through potable water tank isolation valve 37 and potable water connection hose 83 or to potable water discharge 64 through potable water discharge valve 38.

Left and right sides of filter array 76 may be operated independently or concurrently as will be described herein. No cross-connection of left and right side filters exists such that if one side of filter array 76 becomes contaminated that side can remain isolated while remedial procedures are implemented and the non-contaminated side can continue to operate producing potable water.

Left and right sediment filters 50, 51, left and right heavy metals filters 52, 53, and left and right activated carbon filters 54, 55 are preferably fiberglass tanks of three to four cubic foot capacity and are charged with loose filter media according to their identified purpose. Such filters and media are commercially available from companies such as Graver Technologies of Glasgow, Del. Each tank is supplied with a three-way valve 26, 27, 28, 29, 30 31 and operates as a downflow filter with the valve at the normal setting. Reversing the valve setting permits the filter media to be back flushed with incoming water. The third setting of the valve provides a rapid rinse to reset the media within the tank. Operation of filters 50, 51, 52, 53, 54, 55 and valves 26, 27, 28, 29, 30, 31 will be described later in conjunction with FIGS. 3, 7A, 7B, 7C and 8.

At the forward end of enclosure 5 are intermediate water storage tank 60 and potable water storage tank 61. Between storage tanks 60, 61 is located injection pump 65 which connects to ultra-filters 58, 59, at valves 47, 48, to raw water supply at valve 46, to inlet valves 20, 21 at valve 45 and to potable water discharge 64 at valve 49. Injection pump 65 provides means to supply disinfectant solutions to MWPS 1 when the system is to be deactivated for storage as well as means to provide for chlorination of water if desired. Injection pump 65, tanks 60 and 61, left and right pre-filters 56, 57 and left and right micro-filters 58, 59 are accessible through front lockable doors 7′.

Three way valves 26-31 for left and right filters 50, 51, 52, 53, 54, 55 are accessible through side access panels 8 of enclosure 5.

In addition, the entire filter array 76 and tanks 60, 61 may be installed and removed through front doors 7′ without disturbing the elements on bulkhead 66.

Filters, valves and fittings of the system can all be connected using flexible hoses, provided that hoses carrying water exiting filters 54, 55 to pre-filters 56, 57 and beyond are NSF certified for potable water. Other hoses connecting raw water inlet through filters 54, 55 may be non-certified but should be able to maintain integrity at pressures of at least 60 psi. Preferably, all water conduit on bulkhead 66 from raw water inlet 62 through intake control valves 20, 21 and from discharge control valves 22, 23 through potable water discharge 64 and potable water tank isolation valve 37 is NSF certified stainless steel. With the exception of three-way valves 26, 27, 28, 29, 30, 31, all manual valves are preferably stainless steel on/off ball valves. All automatic check or one-way valves, 79, 110-115 are positive closure valves.

The parallel arrangement of left and right intake control valves 20, 21, left and right media filters 50, 51, 52, 53, 54, 55, left and right pre-filters 56, 57, left and right ultra-filters 58, 59 and left and right discharge control valves 22, 23, permits the mobile water purification station 1 to simultaneously produce utility water for such purposes as washing, laundry, or the like, and NSF certified potable water for drinking. Alternatively, the entire system can be used to provide potable water or utility water as needed. Furthermore, the system is rugged and simple to operate and maintain with a limited amount of training. Since all filter media and elements are back flushable within the system, need for replacement of filters over the projected life of the system is significantly reduced. If such replacement does become necessary, the arrangement of elements and the use of common filter media means that such replacement can be accomplished on site. Also, in the event a problem develops with one half of filter assembly 76, it may be shut down for maintenance and repair while the other half remains operable.

Operation of the system to produce potable and utility water will now be described in conjunction with FIGS. 3, 4 and 5.

Submersible pump 14 is connected to raw water intake 62 using a sufficient length of standard supply hose. In the normal set-up of the system on site, a back flush hose is connected to back flush discharge 63 and directed to an area away from either potable water discharge or utility water discharge. An NSF certified potable water hose is connected to potable water discharge 64 and directed to a desired potable water container or existing potable water distribution system. An intermediate utility water hose is connected to intermediate utility water discharge valve 34 and directed to a desired utility water container. Preferably all hoses are color coded to indicate their purpose and prevent their being interchanged. Solar array 3 is assembled and wind generator 4 is secured to mast 6 which is raised to an operating position. Electrical connections from solar array 3 and wind generator 4 to main electrical box 75 and from main electrical box 75 to submersible pump 14 are secured.

To commence production of potable water, all system valves are set as follows: tank valves 26-31 are set to filter, intake control valves 20, 21, discharge control valves 22, 23 and UV lamp discharge valves 35, 36 are set to open with all other valves, particularly potable water isolation valve 37 and main back flush line isolation valve 116, set to closed. Switches 101, 102 on IO 101 and IO 102 control boxes 15, 16 are set to on and the ON/OFF switch 100 on CU 200 control box 17 is pressed until indicator lamp 103 illuminates and watt meter 104 shows a rise. Potable water discharge valve 38 is then opened, submersible pump 14 activated and the system commences producing NSF certified potable water which is discharged at potable water discharge 64. Alternatively, potable water can be stored in potable water storage tank 61 by opening potable water isolation valve 37 and closing potable water discharge valve 38.

Raw water drawn from a source by submersible pump 14 enters MWPS 1 at raw water intake 62 and is directed through centrifugal filter 18, if present, for removal of particles and sediment down to 15 microns. Alternatively, pump screen 14′ provides initial sediment filtration. From centrifugal filter 18, or direct from raw water intake 62 if optional centrifugal filter 18 is not present, water is directed through piping to left and right intake control valves 20, 21 where it is divided between left side 77 and right side 78 of filter assembly 76.

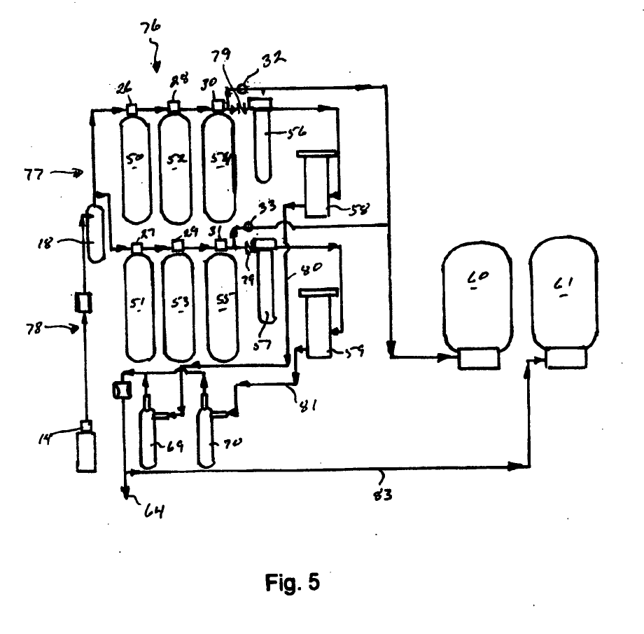

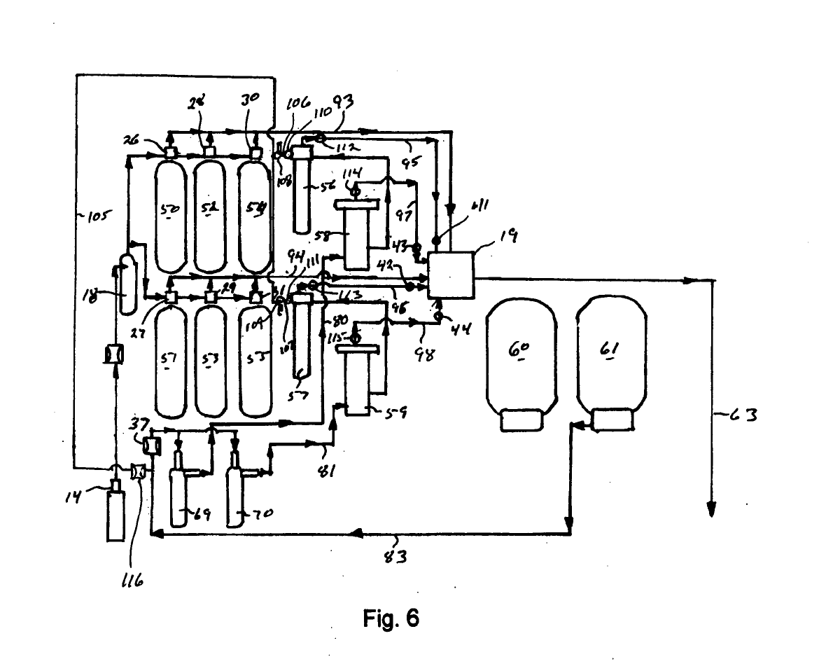

Left side 77 and right side 78 are identical and comprise, respectively, left and right sediment filters 50, 51, left and right heavy metals filters 52, 53, left and right activated carbon filters 54, 55, left and right pre-filters 56, 57 and left and right ultra-filters 58, 59. Left filters 50, 52, 54, 56, 58, and right filters 51, 53, 55, 57, 59 are connected in series as shown in FIGS. 4 and 5 to form separate left 77 and right 78 sides of filter array 77 with no cross-connection between the filters of left side 77 and right side 78. Left and right intake control valves 20, 21, divide water into separate flows for left 77 and right 78 sides.

From valves 20, 21, water flows successively through sediment filters 50, 51, heavy metal filters 52, 53 and activated carbon filters 54, 55, at which point it may be drawn off through left and right intermediate water cutout valves 32, 33 as intermediate or utility water to be stored in intermediate water storage tank 60 or discharged through intermediate water discharge valve 34.

With left and right intermediate water cutout valves 32, 33 closed, water flows from activated carbon filters 54, 55 to left and right pre-filters 56, 57 for removal of particles at least down to 10 microns, then to left and right ultra-filters 58, 59 for removal of particles at least down to 2-4 microns including large microbials such as cysts, Guardia, parasites, etc. Elements of filters 56, 57, 58, 59 are preferably permanent, porous sintered metal and are removable for chemical and/or steam cleaning if necessary. Furthermore, elements of filters 56, 57, 58, 59 may be selected for smaller porosity to provide greater filtration; however, flow rate through the system is lower. For example, providing ultra-filters 58, 59 with elements for removal of particles down to 1 micron results in a flow rate reduction of about 10%. Optimum flow rate for production for EPA/WHO standard potable water at a rate of 5+ gallons per day per person is obtained with the above-identified 10 micron pre-filters 56, 57 and 2-4 micron ultra-filters 58, 59.

As with loose media filters 50-55, pre-filters 56, 57 and ultra-filters 58, 59 are commercially available from companies such as Graver Technologies. Filters 56, 57, 58, 59 are also back flushable using potable water produced by MWPS 1 and stored in potable water storage tank 61. Alternatively, potable water produced by one side of MWPS 1 can be used to back flush the pre-filter and ultra-filter of the other side of MWPS 1.

To maintain separation between left and right filters 50, 51, 52, 53, 54, 55 and pre-filters 56, 57 and ultra-filters 58, 59, the lines from activated carbon filters 54, 55 to pre-filters 56, 57 include one way valves 79. Furthermore, all conduit and hoses from one way valves 79 on through MWPS 1 to storage or discharge are NSF certified for potable water.

Water leaving ultra-filters 58, 59, qualifies as potable water and is directed back to bulkhead 66 through left and right filtered water hoses 80, 81 which connect to left and right discharge control valves 22, 23.

Passing through left and right discharge control valves 22, 23, the now fully filtered water is directed through UV lamp feed line 82 for delivery to left and right ultra-violet lamps 69, 70. Any type of flow through ultra-violet lamp assembly may be used. Each UV lamp 69, 70 is provided with a discharge valve 35, 36 which permits flow to be divided between left UV lamp 69 and right UV lamp 70 or allow flow through both simultaneously. In this manner, the lamps may be alternated to extend their useful life or, if one lamp must be turned off for maintenance or repair, production of potable water may continue using the other lamp.

From UV lamps 69, 70 the now fully filtered and disinfected potable water flows through potable water discharge valve 38 to potable water discharge 64, or, if potable water isolation tank valve 37 is opened and potable water discharge valve 38 is closed, potable water can be collected in potable water storage tank 61 through potable water collection hose 83.

As will be described subsequently, potable water produced by one side of MWPS 1 can be used to back flush pre-filter and ultra-filter of the other side. Also potable water stored in potable water storage tank 61 can be used to back flush left and/or right pre-filters 56, 57 and ultra-filters 58, 59.

If utility water is desired in addition to potable water, it is a simple matter to change one side to utility water production while maintaining potable water production from the other side. For example, to produce utility water from left filters 50, 52, 54, on left side 77 of filter assembly 76, left discharge control valve 22 is closed to stop discharge flow of filtered water from left side 77 and left intermediate water cutout valve 32 is opened. In that arrangement, water will continue to flow through all right filters 51, 53, 55, 57, 59 on the right side 78 of filter assembly 76 and through right discharge control valve 23 as completely filtered water, while water flowing through left filters 50, 52, 54, will be directed to intermediate water storage tank 60 as utility water. Opening intermediate water discharge valve 34 will permit intermediate water to flow from MWPS 1. Note that since left discharge control valve 22 is closed, water will cease to flow through left pre-filter 56 and left ultra-filter 58. Conversely, to produce intermediate utility water from right filters 51, 53, 55, on right side 78 of filter array 76 while maintaining potable water production from left side 77, left discharge control valve 22 is opened and right discharge control valve 23 is closed. Also left intermediate water cutout valve 32 is closed and right intermediate water cutout valve 33 is opened. The operation is thus reversed and left side 77 produces potable water while right side 78 produces intermediate utility water.

If it is desired to store potable water in potable water storage tank 61, potable water discharge valve 38 is closed and potable water tank isolation valve 37 is opened thereby directing potable water directly to tank 61 through potable water collection hose 83. Fourth pressure gauge 74 provides an indication of the water pressure in tank 61 which can then be used to back flush left and right pre-filters 56, 57 and left and right ultra-filters 58, 59.

As intermediate utility water and potable water are produced by MWPS 1, left and right filters 50-59 will build up with residue of materials that they filter out of the water passing through MWPS 1. As a result, over time the filling of pore spaces will inhibit flow thereby reducing the production rate of potable water. In prior art water purification devices such build up has required either replacement of filters necessitating a supply of replacement parts or removal and cleaning of the filters resulting in down time of the purification device as well as proper training or service personnel.

In contrast left and right filters 50-59 of MWPS 1 are fully back flushable to clean accumulated residue without having to remove or replace any filter elements. Such back flushing can be accomplished by operators of MWPS 1 with minimal training. Furthermore, although it is preferred that filters 50-55 be back flushed in pairs, i.e., left and right sediment filters 50, 51, left and right heavy metals filters 52, 53, and left and right activated carbon filters 54, 55, because of the parallel structure of the filter array 76, it is possible to back flush one side while still producing utility or potable water with the other side.

Filters 50-55 are back flushed using incoming. In contrast, pre-filters 56, 57 and ultra-filters 58, 59 are back flushed using potable water stored under pressure in potable water storage tank 61 or directly produced by MWPS 1.

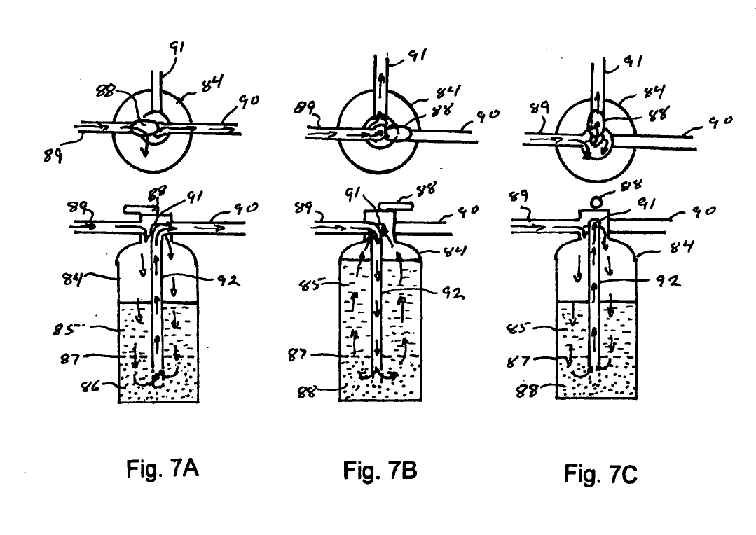

As shown in FIGS. 7A, 7B and 7C, left and right filters 50-55 are loose media, down flow filters and each comprises a fiberglass tank 84 in which filter media 85 is disposed over a bed of gravel 86. A perforated plate 87 may be placed between gravel bed and filter media. At the top of tank 84 is three way valve 88 connecting to intake hose 89, discharge hose 90 and back flush discharge 91. Note that because left and right heavy metals filters 52, 53 are in series between their respective left and right sediment filter 50, 51 and left and right activated carbon filter 54, 55, intake hoses 89 for left and right heavy metals filters 52, 53 correspond to discharge hoses 90 of left and right sediment filters 50, 51. Similarly, discharge hoses 90 of left and right heavy metals filters 52, 53 correspond to intake hoses 89 of left and right activated carbon filters 54, 55. Centrally disposed within tank 84 is tube 92 which, at its proximal end, is connected to valve 88 so as to variably connect to intake hose 89, discharge hose 90 and back flush discharge 91 based on the setting of valve 88. Distal end of tube 92 extends into gravel bed 86 and is perforated. It also may be covered by a water permeable screen of a size to prevent particles of filter media or gravel from entering tube 92.

In the normal, or filter position, shown in FIG. 7A, valve 88 is set to the filter position which connects tube 92 with discharge hose 90. Back flush discharge 91 is closed and intake hose 89 is open so water can enter tank 84 from intake hose 89 and pass down through filter media 85 and gravel bed 86, into tube 92 and out through discharge hose 90.

When valve 88 is set to back flush, as shown in FIG. 7B, tube 92 is connected to intake hose 89, discharge hose 90 is closed and back flush discharge 91 is open. Water from intake hose 89 flows down through tube 92 then upward through gravel 86 and through filter media 85 and out through back flush discharge 91. In this flow pattern, media 85 is raised and separated or fluffed allowing water flow to collect previously filtered particles and carry them out through back flush discharge 91.

When back flushing is completed, valve 88 is set to a quick rinse position, shown in FIG. 7C, where tube 92 is connected to back flush discharge 91, intake hose 89 is open and discharge hose 90 remains closed. In this position, water from intake hose 89 flows into tank 84 in the same manner as for filtering, causing media 85 to resettle. While this is occurring remaining loose residue is picked up by water flowing through tank and will be flushed out through back flush discharge 91.

When quick rinse is completed, valve 88 is reset to the filter position of FIG. 7A.

Back flushing filters 50-55 is a simple matter of setting tank valves 26-31 to the correct position as described above and running MWPS 1. Tank valves 26-31 are readily accessible through side access panels 8 in housing 5.

To back flush left and right sediment filters 50, 51, MWPS 1 is preset so switch 101 of IO 101 control box 15 is set to OFF, tank valves 26-31 are set to the filter position, intake control valves 20, 21 are set to open, UV lamp discharge valves 35, 36 are set to open. All other valves are set to closed. MWPS 1 is started by setting switch 101 of IO control box 15 to ON and tank valves 26, 27 are set to the back flush position. As shown in FIG. 4, back flush discharges 91 of each valve 26, 28 and 30 are connected to left common back flush hose 93 and back flush discharges 91 of valves 27, 29, 31 are connected to right common back flush hose 94. Left and right common back flush hoses 93, 94 connect to back flush manifold 19 as shown in FIG. 8. Because control of flow through common back flush hoses 93, 94 is through tank valves 26-31, separate valves at back flush manifold 19 are not needed.

Back flushing is continued until a noticeable change in the clarity of water exiting back flush discharge 63 is seen at which time valves 26, 27 are set to the quick rinse position of FIG. 7C while 5 to 10 gallons flow through tanks 50, 51 to resettle media 85 in each tank, at which time valves 26, 27 are then reset to the filter position.

The same procedure is followed for filter pairs 52, 53 and 54, 55, setting valves 27, 28 and 29, 30, accordingly with the exception that, preferably, quick rinse of filter pairs 52, 53 is conducted with 10 to 15 gallons and quick rinse of filter pairs 54, 55 is conducted with 15 to 20 gallons.

Because filters left 50, 52, 54 and right filters 51, 53, 55 are connected in series from left and right intake control valves 20, 21, respectively, it is preferred that the filters be back flushed in that order so that water being used to back flush each pair of filters is of the same filtered quality which normally passes through each successive filter.

Back flushing of left and right pre-filters 56, 57 and left and right ultra-filters 58, 59 is conducted using potable water produced by MWPS. In this manner, the cleanliness of filters 56, 57, 58, 59 is maintained.

Since left and right pre-filters 56, 57 are connected in series with left and right ultra-filters 58, 59, back flushing of left and right pre-filters 56, 57 will also result in back flushing of left and right ultra-filters 58, 59. In addition, left and right ultra-filters 58, 59 can be separately back flushed.

Back flushing of both left and right pre-filters 56, 57 and left and right ultra-filters 58, 59 is accomplished using potable water concurrently produced by the side of filter array 77 which is not being back flushed or using potable water stored in potable water storage tank 61.

To back flush left pre-filter 56 using potable water produced by right side 78 of filter array 76, valves of MWPS 1 are set so that intake control valves 20, 21 and UV lamp discharge valves 35, 36 are open, tank valves 26-31 are set to filter and all other valves are closed. Discharge control valves 22, 23 are then opened, left pre-filter back flush valve 41 at back flush manifold 19 is opened and left intake control valve 20 is closed. Opening left pre-filter back flush valve 41 and closing left intake control valve 20 forces water to take a path through right intake control valve 21 to right side 78 of filter array 76, out of filter array 76 through right discharge control valve 23 and back through left discharge control valve 22 to flow in a reverse direction through left ultra-filter 58 then left pre-filter 56 and out through left pre-filter back flush hose 95 to left pre-filter back flush valve 41 and out through back flush manifold 19 and back flush discharge 63. Back flushing continues until a noticeable change in the clarity of the back flush water is observed at which time left pre-filter back flush valve 41 is closed and left intake control valve 20 is opened to return MWPS 1 to normal production.

Back flushing right pre-filter 51 is the same except that right intake control valve 21 is closed and right pre-filter back flush valve 42 is opened. Flow is then through left intake control valve 20 and left side 77 of filter array 76 through left discharge control valve 22 then back through right discharge control valve 23 to right ultra-filter 59 and right pre-filter 57, the back flush passing through right pre-filter back flush hose 96 to exit through right pre-filter back flush valve 42 at back flush manifold 19.

Left and right pre-filters 56, 57 may also be back flushed using potable water produced by MWPS 1 and stored in potable water storage tank 61.

To back flush left and right pre-filters 56, 57 using stored potable water, valves are set so that left and right discharge control valves 22, 23 and left and right UV lamp discharge valves are open, tank valves 26-31 are set to filter and all other valves are set to closed.

To back flush left pre-filter 56, with pressure in potable water storage tank 61 at greater than 60 psi (4.14 bar) as indicated by fourth pressure gauge 74, left and right pre-filter back flush valves 41, 42 are opened until pressure reading of second and third pressure gauges 72, 73 is 0 psi (0 bar). Right pre-filter back flush valve 42 is then closed and potable water tank isolation valve 37 and left discharge control valve 22 are opened allowing pressure in potable water storage tank 61 to force the stored water in reverse flow through potable water collection hose 83, left and right UV lamp discharge valves 35, 36, left and right UV lamps 69, 70, left discharge control valve 22 and left filtered water collection hose 80 through left ultra-filter 58 and left pre-filter 56. Back flush from left pre-filter flows through left pre-filter back flush hose 95 to left pre-filter back flush valve 41 and out through back flush manifold 19 and back flush discharge 63. Back flushing continues until pressure on fourth pressure gauge 74 reads 0 psi (0 bar) at which time left pre-filter back flush valve 41 is closed and all valves are returned to positions previously described for water production by MWPS 1 and pressure in potable water tank 61 is allowed to increase to greater than 60 psi (4.14 bar) as displayed by fourth pressure gauge 74.

Back flushing right pre-filter 51 is the same except that left pre-filter back flush valve 41 is closed and right discharge control valve 23 is opened. Flow is then from potable water storage tank 61 through potable water collection hose 83, left and right UV lamp discharge valves 35, 36, left and right UV lamps 69, 70, right discharge control valve 23 and right filtered water collection hose 81 through right ultra-filter 59 and right pre-filter 57. Back flush from right pre-filter 57 flows through right pre-filter back flush hose 96 to right pre-filter back flush valve 42 and out through back flush manifold 19 and back flush discharge 63. Back flushing continues until pressure on fourth pressure gauge 74 reads 0 psi (0 bar) at which time right pre-filter back flush valve 42 is closed and all valves are returned to positions previously described for water production by MWPS 1 and pressure in potable water tank 61 is allowed to increase to greater than 60 psi (4.14 bar) as displayed by fourth pressure gauge 74.

Whereas left and right ultra-filters 58, 59 are back flushable concurrently with left and right pre-filters 56, 57, left and right ultra-filters 58, 59 are also separately back flushable using production water or potable water stored in potable water storage tank 61 as described above for left and right pre-filters 56, 57 with the exception that left and right ultra-filter back flush valves 43, 44 are used instead of left and right pre-filter back flush valves 41, 42 and back flush from left and right ultra-filters 58, 59 flows through left and right ultra-filter back flush hoses 97, 98, respectively, to left and right ultra-filter back flush valves 43, 44 at back flush manifold 19 for discharge. One-way valves 114, 115 are provided on left and right ultra-filters to prevent back flow of contaminated back flush water.

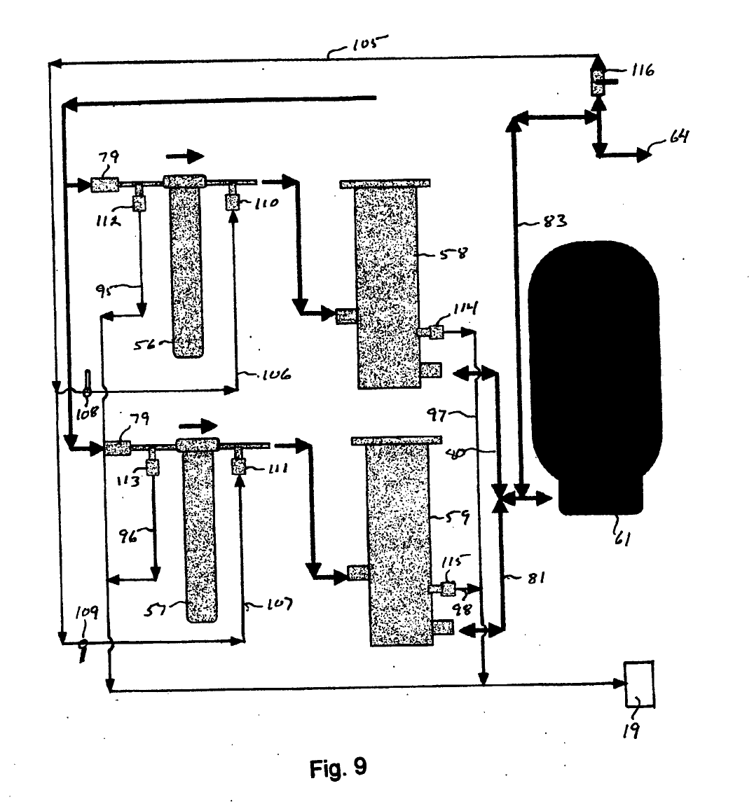

Furthermore, as illustrated in FIG. 9, dedicated back flushing of left and right pre-filters 56, 57 may be provided separate from left and right ultra-filters 58, 59 utilizing stored product water and by-passing left and right ultra-filters 58, 59. In this embodiment, potable water tank isolation valve 37 is closed and main back flush isolation valve 116 is opened. With this setting, pressurized water from potable water tank 61 flows through potable water collection hose 83 and into main back flush line 105. Main back flush line 105 connects to each of left and right pre-filters 56, 57 by secondary back flush lines 106, 107 each of which may be separately controlled by valves 108, 109, thus permitting left and right pre-filters 56, 57 to be separately or concurrently back flushed. Back flush flow enters left and right pre-filters 56, 57 through one-way valves 110, 111 and exits left and right pre-filters 56, 57 through one-way valves 112, 113 into left and right pre-filter back flush hoses 95, 96. One-way valves 79 prevent back flush flow from entering filters 50-55 and one-way valves 110, 111, 112, 113, prevent back flush from flowing in reverse. In this manner, potential contamination from back flush water through back flush manifold 19 and associated back flush lines or hoses is eliminated.

In order to maintain proper flow of back flush water, it is preferred that all one-way valves 79 and 110-115 be positive closure valves that do not rely on water pressure for closure.

To back flush left and right pre-filters 56, 57 apart from left and right ultra-filters 58, 59, using stored water in potable water tank 61, pressure is built-up in tank 61 as previously described herein and control valves are set as also previously described. With left and/or right pre-filter 56, 57 isolated from the system, valve 37 is closed and valve 116 is opened connecting main back flush line 105 to potable water collection hose. Left and/or right pre-filter back flush inflow valves 108, 109 are opened permitting stored potable water to flow from main back flush line 105, through secondary back flush lines 106, 107, and one-way valves 110, 111 into and through left and/or right pre-filters 56, 57. Back flush water from left and/or right pre-filters 56, 57 exits through one-way valves 112, 113 to left and right pre-filter back flush hoses 95, 96 to discharge through back flush manifold 19. Back flush water exiting left and/or right pre-filters 56, 57 is prevented from returning by one-way valves 112, 113 as well as one-way valves 110, 111 and cannot enter the process water stream to flow back to filters 50-55 due to the presence of one-way valves 79.

As is evident from the foregoing procedures, operation of MWPS 1, including back flushing of all filters and filter media, is accomplished in a simple and efficient manner merely by manually setting valves to achieve the desired flow pattern. Furthermore, back flushing of all filters and filter media is accomplished using only the power of water flow provided by submersible pump 14 or the pressure of water stored in potable water storage tank 61, which pressure is obtained through the force of submersible pump 14. No additional pumps are required for the operation of MWPS 1 to produce either intermediate utility water or potable water.

It is noted that prior art systems having check valves or one-way valves to prevent backflow often rely on flapper or pressure dependent valves. Such valves have a weakness in that under less than optimum pressure, they may not close completely, thereby allowing reverse flow leakage which results in contaminating backflow. In the present system, all one-way valves are positive closure valves, i.e. spring biased to closure, and are not dependent upon maintaining a minimum system pressure. Use of such positive closure valves prevents cross-contamination of filters and lines by dirty water during back flushing and makes it possible to obtain and maintain clean, potable water without addition of disinfectants such as chlorine.

However, in the event it is desired to introduce chlorine or other purification chemicals into water produced by the system or to disinfect the system, such as for storage or transportation, MWPS 1 may include injection pump 65 and disinfectant lines 99. Injection pump 65 is preferably a flow operated pump which operates by flow of water through MWPS 1. Alternatively, injection pump 65 may be a low power pump operable from the same power source, i.e., solar array 3 and/or wind generator 4, which powers MWPS 1. Disinfectant lines 99 feed disinfectant from injection pump 65 to MWPS 1 through injection pump inlet valve 45. As with water production and back flushing, procedures for disinfecting all or part of MWPS 1 are simple. Submersible pump 14 is disconnected and stowed together with any supply and discharge hoses. A suction hose for injection pump 65 is placed in a source of disinfectant and the system valves are manually set for water production with injection pump valves 45-49 open.

Thus, to disinfect filters 50-55, injection pump inlet valve 45 is opened to start injection pump 65 and injection pump supply side valve 46 is opened. Disinfectant is run through MWPS 1 for 15 minutes before shutting down.

If it is desired to disinfect pre-filters 56, 57 and ultra-filters 58, 59, in addition to injection pump inlet valve 45 and injection pump discharge valve 46, left and right ultra-filter injection pump valves 47, 48 are opened and disinfectant is run through MWPS 1 for 15 minutes before shutting down.

Furthermore, to disinfect the discharge side of MWPS 1, injection pump discharge side valve 49 is opened and disinfectant run through MWPS 1 for 15 minutes before shutting down.

To shut down MWPS 1, whether for a short period or for transport and storage, all filters are back flushed in accordance with the procedures described herein. ON/OFF button 100 on CU 200 control box 17 is pressed until indicator lamp 103 verifies that electrical generation is off and watt meter 104 on control box 17 is at 0. Switches 101, 102 on IO 101 and IO 102 control boxes 15, 16 are set to OFF and all valves are set such that left and right intake control valves 20, 21, left and right discharge control valves 22, 23 and left and right UV lamp discharge valves 35, 36 are open, tank valves 26-31 are set to filter and all other valves are closed. Supply and discharge hoses and submersible pump 14 are removed and stowed in enclosure 5. Solar array 3 is dismantled and stored in enclosure 5, with individual solar panels 67 stowed in center storage space 10′ between left and right sides 77, 78 of filter array 76. Upper and lower guide tracks may be provided in center storage space 10′ to accommodate solar panels 67 and to provide lateral support for them. Pivoting support frame 68 is configured to fit on supports depending from the top of enclosure 5 in upper storage space 10 so as to be suspended above filters 50-59. Wind generator 4 is dismantled from mast 6, wind turbine blades 13 removed, mast 6 disassembled or retracted and all stored within enclosure 5. Front and rear doors 7, 7′ are closed and locked and side access panels 8 closed and locked. In this manner the entire MWPS 1 is self contained and secure for transportation and/or storage.

The herein described mobile water purification station has been designed for the production of up to 30,000 gallons (151,400 lpd) of EPA/WHO-standard clean and aesthetically pleasing potable water per day. The present configuration will supply potable water for over 5,000 people at a rate of 5+ gallons (18.92 lpd) per day per person. The unit, powered by its integrated solar array and wind generator or gravity feed operates as a stationary, stand-alone system and can be provided with either trailer- or vehicle-mount options.

The MWPS is heavily ruggedized for marginal terrain overland travel, air-drop, and/or seaborne delivery. Engineered for long term trouble-free service and little to no maintenance, the design satisfies the need for a mobile water treatment plant that requires little to no additional hardware or supplies such as chemicals, cartridge filters or other water purification products. A post-treatment, fully mechanical metered injection pump also ensures the integrity of previously-compromised storage facilities when operated as an inline chlorinator. The dosing pump also offers the post-treatment option potential of electrolytic fortification for epidemic control.

The MWPS is simple, tough and easy to maintain with limited know-how under challenging field conditions. There are no automatic back-washing valves, high-tech/high maintenance hardware, or sensitive hydraulics, making it the perfect leave behind piece. The unit is engineered for deployment and operation in less than 45 minutes in remote, marginal, and compromised areas commonly encountered under natural disaster conditions, military support or military theaters, humanitarian relief, MASH units, or the distribution of EPA/WHO-standard potable water with the simultaneous production of non-potable utility water for both agricultural and hygienic purposes such as drip irrigation, cattle washing/feeding, bathing and laundry, etc.

The MWPS is designed to pump and purify water to EPA/WHO standards at a rate of minimal 3 gpm (16,351 lpd) and maximal 25 gpm (136,260 lpd), dependent upon TSS/turbidity levels. Each station is equipped with two pumps that will handle source water from wells, bore holes, lakes, ponds, rivers, streams, agricultural ponds, and catch basins (both deep-set low GPM and high volume shallow-set), as well as to ensure redundancy in operation. Existing water mains where water is not potable can be piped into and out of unit for purification as well. Pumping depth is a maximum of 300 ft although options of different pumps can be engineered to the unit, i.e. 3 gpm (16,351 lpd) to 60 gpm (327,024 lpd) with possible depths of 1 ft (0.30 m) to 600 ft (182.8 m). The unit produces drinking water substantially free of organic, non-organic, biological and viral contaminations under any and all power options. The MWPS design removes impurities from large organic and inorganic sediment through bacteriological/cryptosporidium and viral organisms in the UV stage.

The MWPS adheres to certification standards per ANSI/NSF-61 §8 and ANSI/NSF-53. All hardware and components are EPA- and NSF-approved products and meet or exceed EPA and WHO standards for potable water. The unit removes industrial pollutants including chromium III/VI, lead, mercury, uranium, and arsenic III/V, among others. All operations can be directed via a multi-language or language-neutral control panel. Preferred footprint dimension is 2.44 m (8.0′)×1.22 m (4.0′)×2.21 m (7.25′) with an overall dry skid weight of ˜1727 kg (3800 lbs). Fully serviceable in the field, the unit has a life expectancy of 6-20 years, only requiring media renewal every 2-6 years dependent upon source-water quality and TSS/turbidity levels.

The skid design allows for permanent installation on the ground, at industrial buildings or general village and barracks installations, or on large mobile platforms such as ships and heavy overland vehicles. The entire MWPS 1 can also be mounted on a single-axle trailer suitable for movement over rough terrain, or mounted on standard military Hum-Vees and other similar types of international military/relief agency vehicles. The MWPS can also be deployed by helicopter or air transport, or moved with simple farm equipment such as tractors, horses or mules when trailer-mounted.

As standard equipment, the MWPS includes the following:

1) Skid-mounted unit with full steel enclosure, access service panels, and locking doors.
2) Fully integrated and stowable 5-panel solar array and 1000 W wind generator.
3) Control panel with gauges and charge rate indicator.
4) DC to AC inverter.
5) 12/24V electric bank.
6) Redundant (2) stainless steel ultraviolet (UV) disinfection systems.
7) Flow driven mechanical chemical/chlorine/electrolytic post-treatment injection pump.
8) NSF-approved media vessels, valves, piping and gauges.
9) Bacteriological, cryptosporidium, guardia, and virus removal system.
10) Stainless steel manifold system with approved NSF material.
11) Stainless steel centrifugal filter unit.
12) Pressure storage tanks (2).
13) 100′ inlet and outlet hose.
14) Redundant (2) submersible pumps with 100′ of approved cable per pump.
15) Basic tool kit and spares.
16) Water quality field test kit.
17) Language neutral operation instructions and label system.
18) Operating manual and reference guide.
19) Training and customer support program.
20) Metric or standard hardware.
21) Water quality sample taps.
22) Mobile communications charging terminal for laptop, mobile phones, or satellite phones.

Optional equipment which may be provided includes:

1) Diesel or gas 2.5 kw generator.
2) Single axle Mil-spec trailer with 24V system, lifting hook kit, spare wheel and tire assembly.
3) Civilian grade single 7500 lb rated axle trailer with 12V system.
4) Custom fitted 3 gpm-60 gpm submersible feed pumps and cable assemblies.
5) 100′ rolls of 1″ NSF-approved hose for water feed and product discharge.
6) Non-electric, fully automatic mechanical solar tracking system.
7) Well feed drop pipe kit in 1″×10′ lengths.
8) Approved US DOD Mil-spec collapsible water storage bladder (pillow) tanks.
9) Custom on-site training programs.

While the invention has been described with respect to certain specific embodiments, it will be appreciated that many modifications and changes may be made by those skilled in the art without departing from the spirit of the invention. It is intended, therefore, that all such modifications and changes are within the true spirit and scope of the invention as described herein.

What is claimed is:

1. A self-contained, stand-alone, mobile water purification station capable of producing up to 30,000 gallons of EPA/WHO standard potable water without chemicals comprising:
an enclosure housing an erectable solar array, an erectable wind generator, a battery pack, at least one submersible pump and connecting hose, and a water filtration and purification assembly comprising two parallel water treatment systems operable separately or concurrently to produce filtered utility water and/or purified potable water,
wherein each of said parallel water treatment systems comprises at least one sediment filter, at least one heavy metals filter, at least one activated carbon filter, at least one pre-filter and at least one ultra-filter plumbingly connected in series for water flow therethrough in order from said sediment filter through said ultra-filter, and
wherein each of said parallel water treatment systems is operable to provide filtered or purified water apart from the other of said parallel water treatment systems, and
wherein each of said parallel water treatment systems is separately backflushable using purified water produced by said station to maintain optimum operability.

2. The mobile water purification station of claim 1 wherein said sediment filter, said heavy metals filter and said activated carbon filter comprise loose media filters and wherein said pre-filter and said ultra-filter are porous sintered metal filters, said pre-filter having a pore size at least as small as 10 microns and said ultra-filter having a pore size at least as small as 2 to 4 microns.

3. The mobile water purification station of claim 2 further comprising flow through ultra-violet disinfection lamps in fluid communication with and in series after said ultra-filters.

4. The mobile water purification station of claim 3 further comprising electrical control means providing control and modification of electrical current and voltage supplied by said solar array and said wind generator for operation of said pump and ultra-violet lamps, charging of said battery pack and providing useable electricity.

5. The mobile water purification station of claim 4 further comprising a plurality of manual on/off water flow control valves whereby operation of said water treatment systems, separately or in combination, is controlled by setting said valves in on or off position.

6. The mobile water purification station of claim 5 wherein said enclosure comprises front and rear doors providing access to an interior of said enclosure, an interior bulkhead disposed within said enclosure and dividing said interior into a front section and a rear section, said bulkhead being disposed closer to said rear doors such that said front section comprises the majority of said interior space of said enclosure, said front section housing said parallel water treatment systems and water storage containers and providing storage space for said solar array and said wind generator, and wherein a side of said bulkhead facing said rear doors comprises a surface on which are mounted said electrical control means, said ultra-violet lamps, and primary water flow control valves.

7. The mobile water purification station of claim 6 wherein each of said sediment filter, heavy metals filter and activated carbon filter comprises a container of 3 to 4 cubic foot capacity charged with a loose filter media according to identified purpose and having a three-way valve at an upper end, said three-way valve providing selection between filtration, back flush and quick rinse, and wherein said enclosure further comprises side access panels along upper side-walls providing access to said three-way valves from outside said enclosure.

8. The mobile water purification station of claim 7 further comprising back flush plumbing between each of said sediment filters, said heavy metals filters, said activated carbon filters, said pre-filters and said ultra-filters and a manifold in said rear section of said enclosure, said manifold having a discharge to the outside of said enclosure, whereby back flush discharge from said filters is collected and discharged from said water treatment systems and further comprising plumbing providing potable water to said pre-filters and said ultra-filters for back flushing said pre-filters and said ultra-filters separate and apart from said sediment filters, said heavy metals filters and said activated carbon filters, said plumbing including positive closure one-way valves between said loose media filters and said pre-filters, between said potable water supply and said pre-filters and between said pre-filters, said ultra-filters and said manifold, whereby backflow of contaminated water within said water treatment systems is prevented.

9. In a self-contained, stand-alone, mobile water purification station comprising an enclosure, an erectable solar power array, an erectable wind generator, a battery pack, at least one submersible pump and connecting hose, water purification units and water storage tanks, the improvement comprising;
said water filtration and purification units arranged within said enclosure in two, identical and parallel and separate systems, each system comprising at least one loose media sediment filter, at least one loose media heavy metals filter, at least one loose media activated carbon filter, at least one porous sintered metal pre-filter and at least one porous sintered metal ultra-filter, each filter having a water inlet and a water outlet, said filters being connected in series for water flow therethrough in order from said sediment filter through said ultra-filter, said two identical and parallel systems being separably operable one from the other to produce filtered and purified water;
a raw water inlet connectable to said submersible pump and receiving water from said pump to be filtered and purified by said units, said raw water inlet being connected to water inlets of each of said loose media sediment filters by a first pair of separate manually operable shut off valves whereby raw water is directable to one or the other or both of said parallel systems;
a potable water outlet connectable to water outlets of each of said porous, sintered metal ultra-filters and receiving filtered and purified water produced by said units, said potable water outlet being connected to each of said ultra-filters by a second pair of separate manually operable shut off valves whereby filtered and purified water is receivable from one or the other or both of said parallel systems;
at least one ultra-violet, flow through, water disinfecting unit connected between said second pair of separate manually operable shut off valves and said potable water outlet;
said water storage tanks comprising a potable water storage tank disposed within said enclosure and connected to said water filtration and purification units between said at least one ultra-violet flow through water disinfecting unit and said potable water outlet and adapted to receive and store said filtered and purified water, said potable water storage tank being separable from said water filtration and purification units by a single manually operable shut off valve;
said water storage tanks further comprising an intermediate water storage tank disposed within said enclosure and connected to said water filtration and purification units between said loose media activated carbon filters and said porous sintered metal pre-filters, said intermediate water storage tank being separable from said water filtration and purification units by a manually operable shut off valve at each loose media activated carbon filter;
a back flush system for said water filtration and purification units whereby said loose media filters and said porous sintered metal filters are backflushable separate and apart from production of filtered and purified water, and wherein said porous sintered metal filters are backflushable, separately or in combination, using filtered and purified water produced by said water filtration and purification units, said back flush system comprising a manifold receiving back flush water from each filter, said manifold having a back flush discharge directing back flush water from said enclosure, and said back flush system comprising positive closure one-way valves at said porous sintered metal filters whereby reverse flow of back flush water is prevented;
whereby said self-contained, stand-alone mobile water purification station is adapted to produce filtered utility water and purified potable water to EPA/WHO standards, separately or in combination, and said filters are backflushable within said station using water produced by said station for regeneration and re-use.

10. The self-contained, stand-alone, mobile water purification station of claim 9 further comprising at least one sintered porous metal sediment screen on said at least one submersible pump.

11. The self-contained, stand-alone mobile water purification station of claim 10 wherein said porous sintered metal pre-filter has a pore size at least as small as 10 microns and said porous sintered metal ultra-filter as a pore size at least as small as 2 to 4 microns.

12. The self-contained, stand-alone, mobile water purification station of claim 11 said enclosure mounted to a vehicle trailer chassis and providing storage for said erectable solar power array and erectable wind generator within said enclosure.

13. A self-contained, stand-alone mobile water purification station comprising an enclosure, a raw water inlet into said enclosure, a submersible pump connectable to said raw water inlet and adapted to provide raw water to said mobile water purification station;
said raw water inlet plumbingly connected to first and second water inflow control valves, said first water inflow control valve plumbingly connected to a first water treatment system and said second water inflow control valve plumbingly connected to a second water treatment system;
said first and second water treatment systems being disposed in parallel arrangement within said enclosure, said first and second water treatment systems each comprising a sediment filter, a heavy metals filter, an activated carbon filter a first particle pre-filter and a second particle ultra-filter, said filters being plumbingly connected in series between inflow and outflow ports thereof;
said outflow of each of said second particle ultra filters plumbingly connected to first and second outflow control valves, said ultra filter of said first water treatment system connected to said first outflow control valve and said ultra-filter of said second water treatment system connected to said second outflow control valve;
said outflow control valves plumbingly connected to ultra-violet flow through water disinfecting units, outflow from said ultra-violet units plumbingly connected to a purified water discharge means;
an intermediate filtered water storage tank disposed within said enclosure and plumbingly connected to a mid-flow take-off point between said activated carbon filter and said first particle pre-filter of each of said first and second water treatment systems;
a filtered and purified water storage tank disposed within said enclosure plumbingly connected to said purified water discharge means by a purified water storage conduit downstream of said ultraviolet units and separable therefrom by an on-off control valve;
said purified water storage tank further plumbingly connected to said first and second particle pre-filters of said first and second water treatment systems by a main backflush flow plumbing conduit coming off of said purified water storage conduit and separable therefrom by an on-off control valve, said main backflush flow conduit providing flow of stored purified water for backflushing said particle pre-filters separate from said particle ultra-filters;
a back flush discharge system separate from said filters and plumbing connections therebetween, said backflush system comprising back flush discharge hoses connecting each filter to and back flush manifold, said manifold including on-off valves for each of said particle pre-filters and said particle ultra-filters, and said manifold directing back flush water from said filters to a back flush discharge outside of said enclosure, wherein said back flush discharge and said raw water inlet are on a side of said enclosure opposite from said purified water discharge means; and
a solar power generation array and a wind power generator stored within said enclosure and erectable on the outside of said enclosure providing electrical power for at least said submersible pump, wherein said pump provides sufficient force to generate at least 60 psi within said water treatment systems, said pump force being sufficient to operate said water treatment systems.

14. The self-contained, stand-alone mobile water purification station of claim 13 further comprising an intermediate filtered water discharge port connected to said intermediate filtered water storage tank.

15. The self-contained, stand-alone mobile water purification station of claim 14 wherein said sediment filters, said heavy metals filters and said activated carbon filters comprise loose media filters having filter media appropriate to their function and further comprising three-way valves providing inflow, outflow and back flush discharge, wherein, in each water treatment system, the inflow of said sediment filter is connected to said inflow control valve, said outflow of said sediment filter is connected to said inflow of said heavy metals filter, said outflow of said heavy metals filter is connected to said inflow of said activated carbon filter and said outflow of said activated carbon filter is connected to an inflow of said first particle pre-filter through a T-fitting and a positive closure one-way check valve, said T-fitting also connects to said intermediate filtered water take-off through an on-off valve, and said back flow discharge of said three-way valves connects to said back flush discharge hoses.

16. The self-contained, stand-alone mobile water purification station of claim 15 wherein said first particle pre-filter comprises a porous sintered metal filter having a pore size at least as small as 10 microns and said second particle pre-filter comprises a porous sintered metal filter having a pore size at least as small as 2 to 4 microns.

17. The self-contained, stand-alone mobile water purification station of claim 16 wherein all plumbing conduit after said activated carbon filters comprises material certified for potable water.

18. The self-contained, stand-alone mobile water purification station of claim 17 wherein all on-off control valves are stainless steel ball valves.

19. The self-contained, stand-alone mobile water purification station of claim 18 a trailer chassis supporting said enclosure.

20. The self-contained, stand-alone mobile water purification station of claim 19 further comprising an optional chlorine injection pump.
